(19) United States
(12) Patent Application Publication
(10) Pub. No.: US 2012/0032884 A1
(43) Pub. Date: Feb. 9, 2012

(54) WIRELESS MOUSE

(75) Inventor: TSUNG-SHIH LEE, Tu Cheng (TW)

(73) Assignee: Cheng Uei Precision Industry Co., LTD., Tu Cheng City (TW)

(21) Appl. No.: 12/851,509

(22) Filed: Aug. 5, 2010

(51) Int. Cl. G06F 3/033

(52) U.S. Cl. 345/163

(57) ABSTRACT

A wireless mouse includes a mouse body, a main body, a power switch, a connection portion fixed on the main body, and an elastic shell covering the main body. The main body includes a baseboard on the mouse body, a pressing element on a surface of the baseboard, and board elements connecting each other. The baseboard defines a holding slot. The pressing element includes a holding portion from which a pressing portion extends. Each board element includes a base plate. The board element next to the baseboard includes a resisting piece protruding from the base plate to selectively depress the pressing portion. The power switch is secured in the holding slot and includes a button. The wireless mouse utilizes the pressing portion to multiply movement distance of turned resisting piece during using, thereby providing the button with enough movement distance so that the power switch can be reliably actuated.

### BACKGROUND OF THE INVENTION

1. Field of the Invention

The present invention generally relates to a mouse, and particularly relates to a bendable wireless mouse.

2. Description of Prior Art

With the advent of Windows Operating System, a computer mouse has become an indispensable computer peripheral equipment. It has brought great convenience to users, and improved working efficiency greatly. Therefore, since the emergence of the mouse, new technology and new products of the mouse, from a mechanical mouse to an optical mouse, from a wired mouse to a wireless mouse, are continuously coming out. Due to no connection cable being needed, a wireless mouse is convenient to use, and therefore, it is rapidly gaining in popularity. For power-saving purpose, a power switch is provided for powering off the wireless mouse when the wireless mouse is not operated. Typically, the power switch is positioned outside a wireless mouse to be manually accessible and operable so that a user can activate the wireless mouse by simply depressing or switching the power switch.

However, because of being positioned outside the wireless mouse, the power switch is susceptible to incorrect or undesired activation when the mouse is not in use, thereby leading to inconvenience and trouble of using the mouse.

### SUMMARY OF THE INVENTION

To solve the above-mentioned problem, an objective of the present invention is to provide a wireless mouse, which is capable of reliably turning on/off a power switch thereof

To achieve the above objective, the invention provides a wireless mouse comprising a mouse body, a main body, a power switch, a connection portion, and an elastic shell. The main body comprises a baseboard, a pressing element, and a plurality of board elements. The baseboard is fixed on an end of the mouse body and defines a holding slot in a side thereof The pressing element is secured to a surface of the baseboard. The pressing element comprises a holding portion and a pressing portion extending from a side of the holding portion. The plurality of board elements connects with each other. One of the board elements connects with the baseboard. An angle is formed between the surface of baseboard and a surface of the one of the board elements, and between opposing surfaces of two adjacent board elements. Each of the board elements comprises a base plate. The board element next to the baseboard comprises a resisting piece protruding from the base plate thereof to selectively depress the pressing portion. The power switch is secured in the holding slot of the baseboard. The power switch comprises a button. An end of the pressing portion of the pressing element selectively depresses the button of the power switch. The connection portion is fixed on the main body. The elastic shell covers the main body.

The wireless mouse of present invention utilizes the pressing portion of the pressing element, which functions similar to a lever, to multiply movement distance of a turned resisting piece during using, thereby providing the button of the power switch with enough movement distance. As a result, the power switch can be reliably actuated.

### BRIEF DESCRIPTION OF THE DRAWINGS

The present invention may be best understood through the following description with reference to the accompanying drawings, wherein:

FIG. 1 is a perspective view of a wireless mouse according to an embodiment of the present invention;

FIG. 2 is an exploded view of the wireless mouse shown in FIG. 1;

FIG. 3 is a side view of a main body of the wireless mouse shown in FIG. 2 after being assembled;

FIG. 4 is a perspective view of a baseboard of the main body of the wireless mouse shown in FIG. 2;

FIG. 5 is a perspective view of a pressing element of the main body of the wireless mouse shown in FIG. 2;

FIG. 6 is a perspective view of the baseboard, the pressing element, and a power switch of the wireless mouse shown in FIG. 2, wherein the base board, the pressing element, and the power switch are assembled together;

FIG. 7 is a perspective view of the main body and a power switch of the wireless mouse shown in FIG. 2, wherein the main body and the power switch are assembled together; and

FIG. 8 is a side view of the wireless mouse shown in FIG. 1, wherein the wireless mouse is bent.

### DETAILED DESCRIPTION OF THE PREFERRED EMBODIMENT

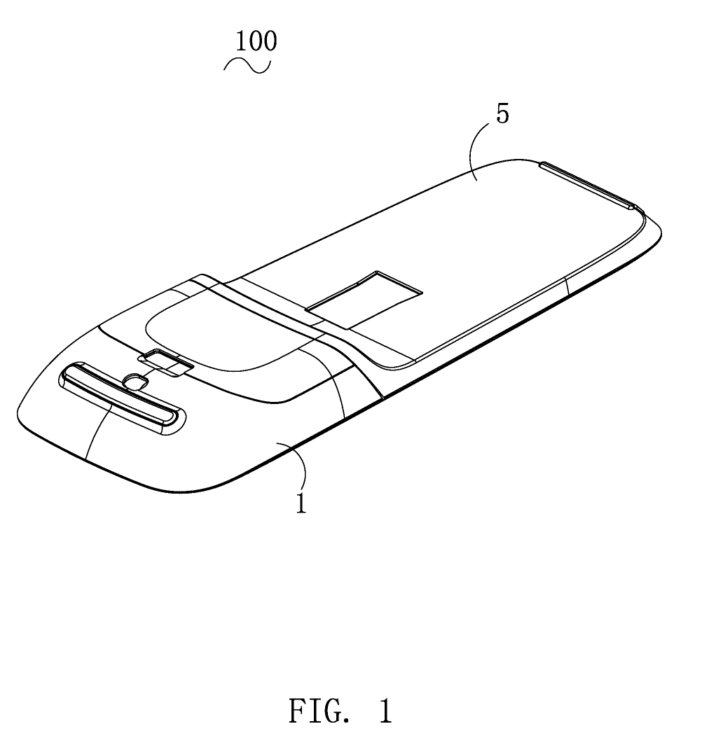

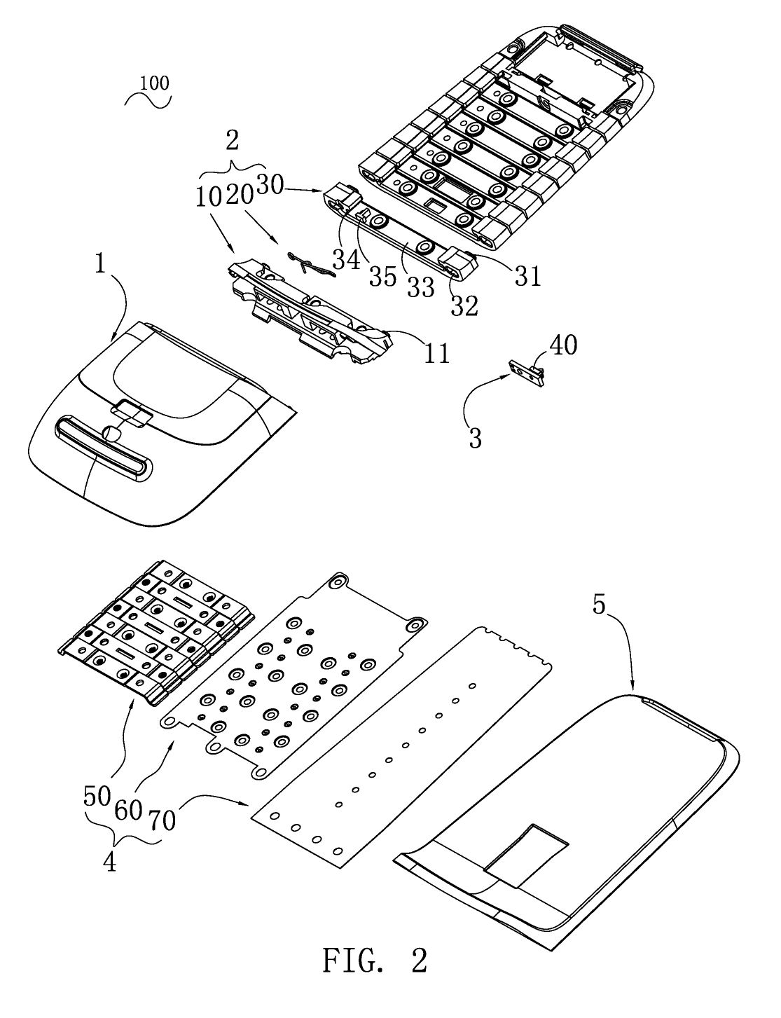

With reference to the drawings and in particular to FIGS. 1 and 2, a wireless mouse constructed in accordance with the present invention, generally designated at 100, comprises a mouse body 1, a main body 2, a power switch 3, a connection portion 4, and an elastic shell 5.

Referring to FIGS. 2 and 4, the main body 2 includes a baseboard 10, a pressing element 20, and a plurality of board elements 30. The baseboard 10 is mounted to an end of the mouse body 1. The baseboard 10 comprises a pair of first holding bumps 11 forwardly protruding from two side portions of a front surface thereof The baseboard 10 defines a holding slot 12 in the front surface thereof, and is recessed besides the holding slot 12 to form a receiving groove 13 in communication with the holding slot 12. The receiving groove 13 has a sidewall through which a holding hole 14 is defined. The baseboard 10 also defines in the front surface thereof a supporting groove 15 at a location adjacent to one of the first holding bumps 11.

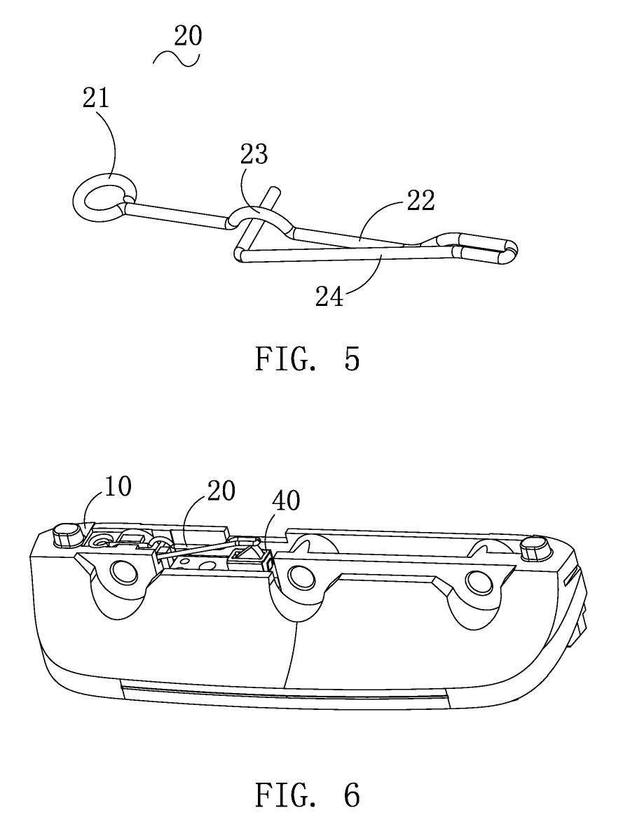

Referring to FIGS. 2, 5, and 6, the pressing element 20 is secured to the front surface of the baseboard 10. The pressing element 20 comprises a circular holding portion 21, and a bar-like pressing portion 22 extends from a side of the holding portion 21. An arc-shaped force-receiving section 23 is formed on a middle of the pressing portion 22 and protrudes outside the baseboard 10. The pressing portion 22 comprises an L-shaped elastic portion 24 formed by bending an end thereof The holding portion 21 is secured in the supporting groove 15 of the baseboard 10. The elastic portion 24 has an end received in the receiving groove 13 and secured in the holding hole 14 to provide a restoration force after removal of a pressure acting on the pressing element 20, thereby preventing permanent deformation of the pressing element 20 after repeated depression of the pressing portion 22.

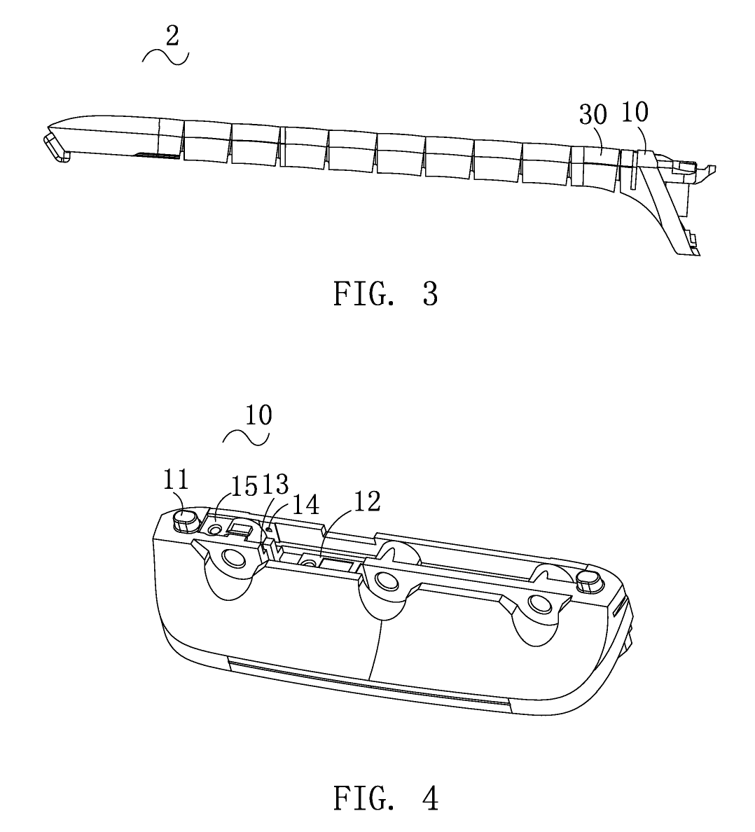

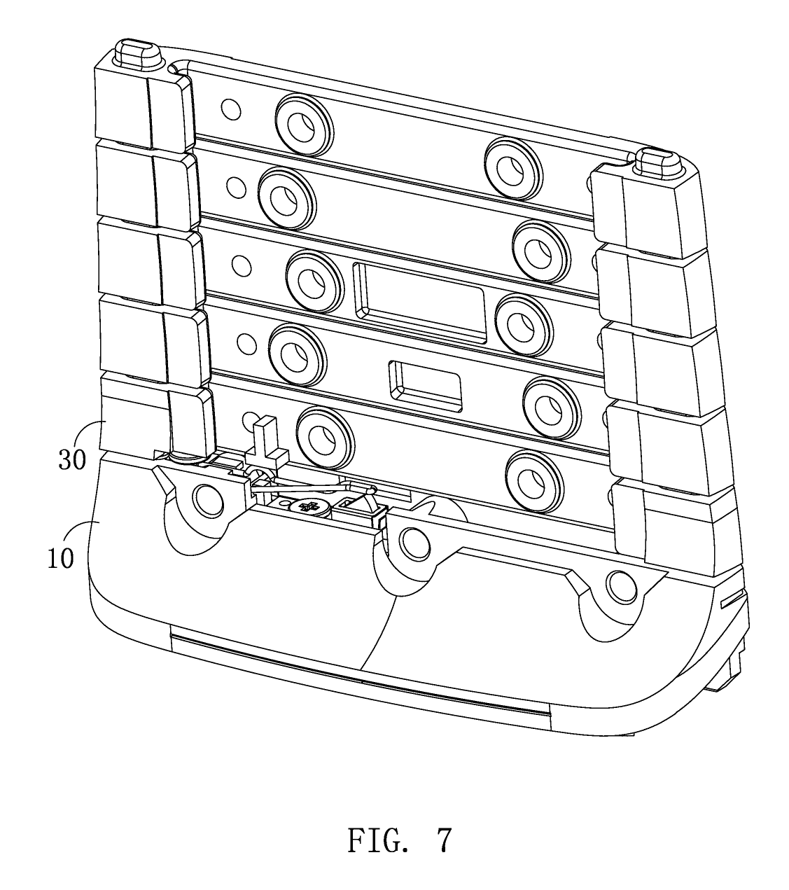

Referring to FIGS. 2, 3 and 7, each of the board elements 30 comprises a pair of second holding bumps 31 forwardly protruding from two side portions of a front surface thereof, and a pair of holding grooves 32 defined in two side portions of a rear surface thereof corresponding to the first holding bumps 11 or the second holding bumps 31. Each of the board elements 30 comprises a rectangular base plate 33. The base plate 33 of the board element 30 defines a pair of connecting grooves 34 in opposite sides of the base plate 33. One of the board elements 30 that is next to the baseboard 10 comprises a T-shaped resisting piece 35 protruding from the base plate 33 thereof. The resisting piece 35 is engageable with the force-receiving section 23 of the pressing portion 22. The baseboard 10 connects with one of the board elements 30 and adjacent ones of the board elements 30 connect with each other. An angle is formed between the front surface of the baseboard 10 and the rear surface of the board element 30 connected thereto, and an angle is also formed between the front surface and the rear surface of two adjacent board elements 30. The first holding bumps 11 and the second holding bumps 31 are received respectively in corresponding holding grooves 32, thereby properly positioning the board elements 30 during assembling the main body 2.

Referring to FIGS. 2, 6, and 7, the power switch 3 is secured in the holding slot 12 of the baseboard 10. The power switch 3 comprises a button 40 that is depressible by an end of the pressing portion 22 of the pressing element 20.

Referring to FIGS. 1 and 2, the connection portion 4 is fixed to the main body 2 and comprises a plurality of engaging plates 50, an upper flectional plate 60, and a lower flectional plate 70. The engaging plates 50 are inserted into and retained in the connecting grooves 34, respectively. The upper and lower flectional plates 60, 70 are respectively positioned on upper and bottom surfaces of the baseboard 10 and the board elements 30 for fastening the base board 10 and board elements 30 as an integral unit and providing a retention force for the main body 2 in a bent condition.

Referring to FIGS. 1 and 2, the elastic shell 5 is provided for covering the main body 2.

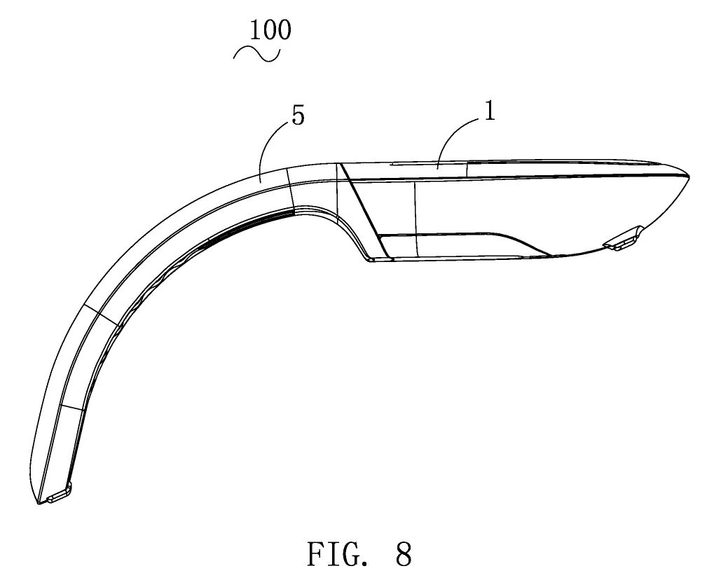

Referring to FIGS. 1, 2, 3, 7, and 8, when the wireless mouse 100 is bent, the one of the board elements 30 that is next to the baseboard 10 is turned at such an angle that the rear surface of the board element 30 comes into tight contact with the front surface of the baseboard 10. Simultaneously, the remaining board elements 30 are turned respectively at an angle to make the front surface and the rear surface of two adjacent board elements 30 contacting each other. The resisting piece 35 is moved with the turning of the board element 30 next to the baseboard 10 to depress the force-receiving section 23 of the pressing element 20. Being acted upon by the resisting piece 35, the pressing portion 22 of the pressing element 20 turns an angle around the holding portion 21 so that the end of the pressing portion 22 that corresponds to the button 40 of the power switch 3 moves a distance to engage and actuate the button 40, thereby turning on the power of the wireless mouse 100.

When the wireless mouse 100 is not operated, the wireless mouse 100 is expanded to restore an original flat shape. Under the circumstances, the pressing element 20 is acted upon by the restoration force thereof and a force applied to the elastic portion 24 by the holding hole 14 to restore the original condition. Simultaneously, the button 40 of the power switch 3 restores to an original state as the end of the pressing portion 22 of the pressing element 20 restores and thus the wireless mouse 100 is powered off

The wireless mouse 100 of present invention utilizes the pressing portion 22 of the pressing element 20, which functions similar to a lever, to multiply movement distance of turned resisting piece 35 during using, thereby providing the button 40 of the power switch 3 with enough movement distance. As a result, the power switch 3 can be reliably turned on and off

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A wireless mouse, comprising:
a mouse body;
a main body comprising a baseboard, a pressing element, and a plurality of board elements, the baseboard being fixed on an end of the mouse body, the baseboard defining a holding slot in a side thereof, the pressing element being secured to a surface of the base board, the pressing element comprising a holding portion and a pressing portion extending from a side of the holding portion, the plurality of board elements connecting with each other, one of the board elements connecting with the base board, an angle being formed between the surface of base board and a surface of the one of the board elements, and between surfaces of two adjacent board elements, each of the board elements comprising a base plate, the board element that is next to the base board comprising a resisting piece protruding from the base plate thereof to selectively depress the pressing portion;
a power switch secured in the holding slot of the baseboard, the power switch comprising a button, an end of the pressing portion of the pressing element being engageable and depressing the button of the power switch;
a connection portion fixed on the main body; and
an elastic shell covering the main body.

2. The wireless mouse as claimed in claim 1, wherein the baseboard comprises a receiving groove defined at a side of the holding slot and communicating with the holding slot, the receiving groove defining a holding hole through a side wall thereof, the pressing portion of the pressing element comprising an elastic portion formed by bending an end thereof, the elastic portion comprising an end received in the receiving groove and secured in the holding hole.

3. The wireless mouse as claimed in claim 1, wherein the pressing portion comprises a force-receiving section protruding from a middle portion thereof to the base board, the resisting piece selectively depressing the force-receiving section.

4. The wireless mouse as claimed in claim 1, wherein the base board comprises a pair of first holding bumps protruding from side portions of a surface thereof and defines a supporting groove adjacent to one of the first holding bumps in a surface thereof, the holding portion being secured in the supporting groove of the base board, the plurality of board elements each comprising a pair of second holding bumps protruding from side portions of a surface thereof, and a pair of holding grooves defined in side portions of other surface thereof corresponding to the first holding bumps or the second holding bumps for receiving the first holding bumps or the second holding bumps.

5. The wireless mouse as claimed in claim 1, wherein each of the board elements defines a pair of connecting grooves in opposite sides of the base plate thereof, the connection portion comprising a plurality of engaging plates, an upper flectional plate, and a lower flectional plate, the engaging plates being inserted into the connecting grooves, the upper flectional plates and the lower flectional plates being mounted respectively to upper and bottom surfaces of the base board and the board elements.
